(19) United States
(12) Patent Application Publication
(10) Pub. No.: US 2014/0190511 A1
(43) Pub. Date: Jul. 10, 2014

(54) DUST REMOVER

(71) Applicant: Makoto Takayanagi, Shizuoka-pref. (JP)

(72) Inventor: Makoto Takayanagi, Shizuoka-pref. (JP)

(73) Assignee: TRINC.ORG, Shizuoka-pref. (JP)

(21) Appl. No.: 14/190,052

(22) Filed: Feb. 25, 2014

Related U.S. Application Data
(62) Division of application No. 11/739,278, filed on Apr. 24, 2007, now abandoned.

(51) Int. Cl. B08B 6/00

(52) U.S. Cl. CPC B08B 6/00
USPC 134/1

(57) ABSTRACT

A dust remover which comprises a power supply and an electrode applied with voltage by said power supply. The dust attached to the object of dust removal is removed therefrom by bringing the electrode into contact with the object of dust removal or approaching toward the object of dust removal. The object of dust removal is a conductor and/or an insulator. The voltage applied to said electrode is a pulsed voltage of plus and minus or an AC voltage of plus and minus. Or the voltage is a DC voltage having the same polarity with that of electricity with which the dust is charged, or the voltage is a DC voltage having an opposite polarity to that of electricity with which the dust is charged. The object of dust removal includes at least a ball for “Pachinko”, a car body, a printed board, a metal box or a part thereof, a frame for glasses, a plastic lens, a plastic box or a part thereof, a fiber, a wood, a paper box or a part thereof.

This divisional U.S. Patent Application claims the benefit of priority of the prior U.S. patent application Ser. No. 11/739,278 filed on Apr. 24, 2007, of the same title, by the same inventor.

### TECHNICAL FIELD

This invention generally relates to a dust remover or dust removal device, and more particularly, to a dust remover for removing dust by coulombic reaction force or attraction force generated by application of voltage.

### BACKGROUND OF INVENTION

Conventional dust removers include:
(1) a system in which dust is mechanically wiped away with a brush,
(2) a system in which dust is scraped away with an adhesive tape or an adhesive roller,
(3) a system in which dust is blown away by air blow or fan blow,
(4) a system in which dust is sucked in by vacuum suction,
(5) a system in which supersonic vibration is applied to facilitate the scraping of dust, and
(6) a system in which static charge is removed using a static eliminator to facilitate the scraping of dust, and the like

As mentioned above, with the conventional contact type of dust removal systems, dust is wiped away with a brush, or dust is scraped away with an adhesive tape. In these cases dust is difficult to remove or dust is adhered again at once since static charge is generated inevitably. Furthermore, with the conventional non-contact type of dust removal systems, since air blow is used to blow dust away, the re-adhesion of dust is promoted. In particular since the air blow or fan blow is not used under the clean atmosphere such as clean room or clean bench the non-contact dust removing is difficult.

Therefore, it is an object of the present invention to provide a dust remover which overcomes the above-mentioned disadvantages.

### SUMMARY OF INVENTION

To accomplish the object, there is provided a dust remover which comprises a power supply and an electrode applied with voltage by said power supply, in which the dust attached to the object of dust removal is removed therefrom by bringing said electrode into contact with the object of dust removal or approaching toward the object of dust removal.

There is also provided a dust remover for balls for use in “Pachinko” game or for coins for use in a game machine which comprises an entrance gate for introducing balls or coins, an electrode disposed so that the introduced balls or coins are brought into contact with or approached the electrode, said electrode being electrically isolated from the other parts and applied with the voltage to remove the dust, a discharge gate for discharging the balls or coins, a first isolator for separating the balls or coins on or adjacent said electrode from the others in the entrance gate and transferring the separated balls or coins toward said electrode, a second isolator for separating the balls or coins in the discharge gate from the balls or coins on or adjacent said electrode and transferring the balls or coins toward said discharge gate.

There is also provided a dust remover which comprises a dust repelling electrode which is disposed in contact with or adjacent the object of dust removal and fed by a power supply, and an ionizer for issuing ions toward the circumference of the object of dust removal.

There is also provided a dust remover which comprises a dust repelling electrode which is disposed in contact with or adjacent the object of dust removal and fed by a power supply, and a dust attracting opposite electrode disposed on the opposite side of said dust repelling electrode and separated therefrom.

There is also provided a dust remover which comprises a dust suction vacuum device for sucking the departed dust in from a dust attracting electrode for attracting the dust, and a dust attracting electrode for attracting the dust, and/or a dust repelling electrode for flying and floating the dust from the object of dust removal.

There is also provided a dust remover which comprises an air blower for flying the dust away, a dust attracting electrode for attracting the dust, and/or a dust repelling electrode for flying and floating the dust from the object of dust removal.

There is also provided a dust remover which comprises a dust flying-away fan and/or air blower disposed in an upper stream, a dust repelling electrode disposed in a downstream from the fan and/or the blower, a dust attracting electrode disposed in a further downstream from the object of dust removal, and a dust suction fan at the end of the stream.

Other objects, features, and advantages of the present invention will be explained in the following detailed description of the invention having reference to the appended drawings:

### BRIEF DESCRIPTION OF DRAWINGS

FIG. 1 is a view for explanation on mechanism of dust removal in case that the object of dust removal is a conductor, in which FIG. 1a shows the state that the dust is attached to the object of dust removal, FIG. 1b is a view for explanation on mechanism of non-contact system for dust removal, and FIG. 1c is a view for explanation on mechanism of contact system for dust removal.

FIG. 2 is a view for explanation on mechanism of dust removal in case that the object of dust removal is an insulator, in which FIG. 2a shows the state that the dust is attached to the object of dust removal, FIG. 2b is a view for explanation on the mechanism in which the dust is removed from the side that dust is attached, and

FIG. 2c is a view for explanation on the mechanism in which the dust is removed from the side opposite to that dust is attached.

FIG. 3 is a view for explanation on types of voltage applied to remove dust, in which FIG. 3a shows the state that the dust is attached to the object of dust removal, FIG. 3b shows that the applied voltage is a pulse DC, FIG. 3c shows that the applied voltage is AC, and FIG. 3d shows that the applied voltage is a plus DC, and FIG. 3e shows that the applied voltage is a minus DC.

FIG. 4 is a view for explanation on the case in which the object of dust removal is a car body.

FIG. 5 is a view for explanation on the case in which the object of dust removal is a ball for use in the game “Pachinko”.

FIG. 6 is a view for explanation on the case in which the object of dust removal is a printed board.

FIG. 7 is a view for explanation on the case in which the object of dust removal is a metal box.

FIG. 8 is a view for explanation on the case in which the object of dust removal is an insulator such as plastic, in which FIG. 8a is a view showing the electrode moved toward the plastic from the side opposite to the dust, and FIG. 8b is a view showing the electrode moved toward the plastic from the side the dust is attached to.

FIG. 9 is a view for explanation on the case in which the object of dust removal is a plastic or a glass lens, in which FIG. 9a shows the electrode moved toward the dust from the opposite side of the lens, and FIG. 9b shows the electrode moved toward the dust from the side the dust is attached to.

FIG. 10 is a view for more detailed explanation on the dust remover for removing dust from the balls for use in the game “Pachinko”.

FIG. 11 is a view for explanation on phenomenon of dust return.

FIG. 12 is a view showing the dust remover of the 11th embodiment.

FIG. 13 is a view showing the dust remover of the 12th embodiment, FIG. 13a shows the state that the dust is attached to the object of dust removal, and FIG. 13b shows the state that the dust is removed from the object of dust removal.

FIG. 14 is a view showing the dust remover of the 13th embodiment.

FIG. 15 is a perspective view showing more detailed examples of electrodes, that is, dust repelling electrode and dust attracting electrode, in which FIG. 15(a) shows a needle shape electrode, FIG. 15(b) shows a one dimensional array of needle shape electrodes, FIG. 15(c) shows a two dimensional array of needle shape electrodes, FIG. 15(d) shows a rod electrode, FIG. 15(e) shows a line or rod-like shape, FIG. 15(f) shows a mesh shape, FIG. 15(g) shows a plate-like shape and FIG. 15(h) shows a ring shape.

FIG. 16 is a view showing three examples of the dust remover provided with a dust suction device according to the 15th embodiment, in which FIGS. 16a and 16b show the examples in which a dust suction vacuum device and a dust attracting electrode are disposed on the same side of the object of dust removal, and FIG. 16c shows the example in which a dust suction vacuum device and a dust attracting electrode are disposed on the opposite side of the object of dust removal.

FIG. 17 is a view showing a dust remover provided with an air blower according to 16th embodiment, in which FIG. 17a shows the case in which a dust attracting electrode and an air nozzle of air blower are disposed on the same side of the object of dust removal, and FIG. 17b shows the case in which a dust repelling electrode and an air nozzle of air blower are disposed on the opposite side of the object of dust removal.

FIG. 18 is a view showing the dust remover according to 17th embodiment.

FIG. 19 is a view showing the embodiment in which the object of dust removal is a car body, in which FIG. 19a shows the dust removal mechanism of the car body corresponding to the embodiment shown in FIG. 16c and FIG. 19b shows the dust removal mechanism of the car body corresponding to the embodiment shown in FIG. 17b.

### DETAILED DESCRIPTION OF THE INVENTION

### First Embodiment

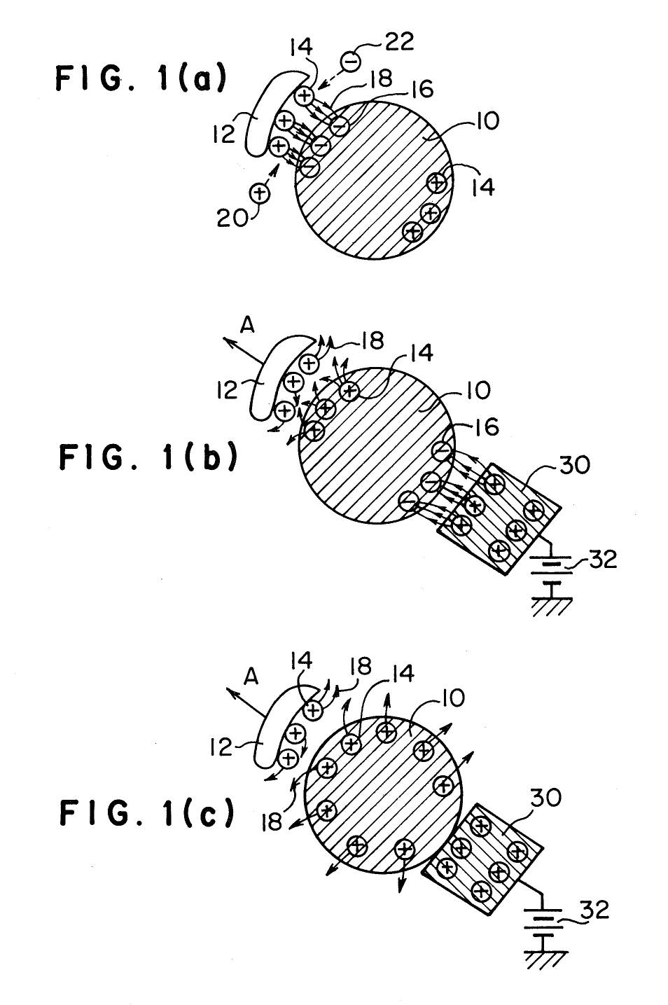

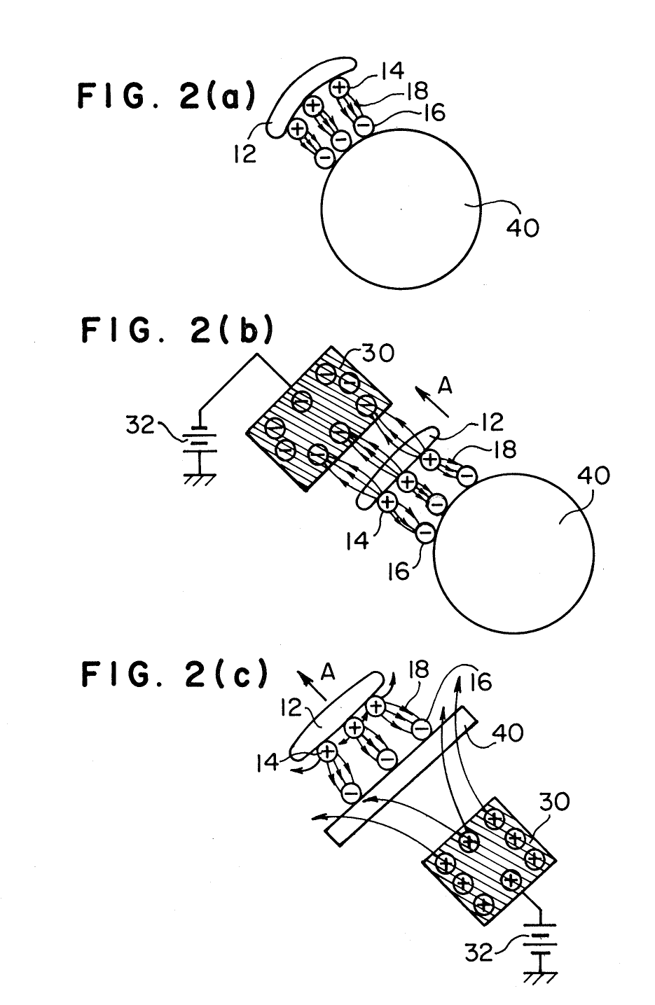

FIG. 1 is a view for explanation on mechanism of dust removal in case that the object of dust removal is a conductor, FIG. 1a shows the state that the dust is attached to the object of dust removal, FIG. 1b is a view for explanation on mechanism of non-contact system for dust removal. Although, for clarity of principle, in FIG. 1 the object of dust removal and dust are separately shown to show plus electric charge, minus electric charge, and electric flux line, in fact the dust is attached to the object of dust removal. In FIGS. 2 and 3 the object of dust removal and dust are shown the same as that of FIG. 1.

In FIG. 1a, when the dust 12 charged with plus electricity 14 approaches to or is attached to the object of dust removal, equal quantity of plus electricity 14 and minus electricity 16 are induced inside the object of dust removal. While the minus electricity 16 thus induced moves to the position adjacent the dust, the plus electricity 14 is pushed toward the opposite side. The plus electricity 14 with which the approached dust is charged and the minus electricity 16 inside the object of dust removal are attracted to each other due to the generated attracting force and then the dust is attached to the object of dust removal.

Now considering electric flux line, the electric flux lines coming out from the plus electricity 14 of dust are terminated at the minus electricity 16, and thus the electric flux lines are closed. Assuming that a static eliminator in which plus ions and minus ions are generated to remove electricity or electric charge from the object of dust removal by applying ions thereto is used to remove the dust, that is, plus ions 20 and minus ions 22 are supplied to the object of dust removal, plus electricity 14 or minus electricity is not affected by plus ions 20 and minus ions 22 since the electric flux lines are closed. Consequently the dust can not be removed.

In FIG. 1b, when the electrode 30 charged with plus electricity by a power supply 32 is approximated to or comes close to the object of dust removal 10 (non-contact), if the voltage of the electrode is high enough, the attracting force of minus electricity 16 within the object of dust removal induced by the electrode overcomes the attracting force induced by plus electricity 14 with which the dust 12 is charged, and thus is attracted to the side of the electrode 30. Consequently the plus electricity moves to the dust side within the object of dust removal. The plus electricity thus moved and the plus electricity 14 of the dust 12 repel to each other. As a result the dust is flied away as shown by an arrow A and then removed from the object of dust removal.

Considering electric flux line, the plus electricity 14 of the object of dust removal and the plus electricity 14 of the dust are terminated without being closed. In case that the electric flux line is not closed, repulsive force works.

In FIG. 1c, the object of dust removal is brought into contact with the electrode 30 which is charged with plus electricity by the power supply 32. At that time, if the electrode 30 is applied with plus voltage sufficiently to overcome the attracting force induced by the dust, the object of dust removal is made to be charged with plus electricity. In a similar way to the reason explained associated with FIG. 1b, the repulsive force is generated between the plus electricity 14 of the dust 12 and the plus electricity 14 of the object of dust removal 10 to fly the dust 12 away from the object of dust removal 10 as shown by an arrow A.

### Second Embodiment

FIG. 2 is a view for explanation on mechanism of dust removal in case that the object of dust removal is an insulator, FIG. 2a shows the state that the dust is attached to the object of dust removal, FIG. 2b is a view for explanation on the mechanism in which the dust is removed from the side dust is attached and FIG. 2c is a view for explanation on the mechanism in which the dust is removed from the side opposite to that dust is attached.

In FIG. 2a, when the dust 12 charged with plus electricity 14 approaches to an insulator 40, that is, the object of dust removal charged with minus electricity 16, the dust 12 and the object of dust removal 40 attract to each other due to the attracting force generated between the plus electricity 14 with which the dust is charged and the minus electricity 16 with which the object of dust removal is charged, and as a result the dust 12 is attached to the object of dust removal 40.

In FIG. 2b, when the electrode 30 applied with minus voltage is moved toward the side the dust 12 is attached (non-contact), if the voltage applied to the electrode 30 is high enough, the attracting force due to the minus voltage generated by the electrode 30 overcomes the attracting force due to minus electricity 16 with which the object of dust removal 40 is charged and therefore the minus voltage generated by the electrode 30 attracts plus electricity with which the dust is charged. Consequently the dust 12 is removed from the object of dust removal 40.

In FIG. 2c, when the electrode 30 is moved toward the object of dust removal 40 from the side opposite to the dust 12, if the electrode 30 is applied with plus voltage which overcomes the attracting force between the object of dust removal and the dust, the plus electricity applied by the electrode 30 repels plus electricity with which the dust 12 is charged and then flies the dust away.

### Third Embodiment

FIG. 3 is a view for explanation on types of voltage applied to remove dust, FIG. 3a shows the state that the dust is attached to the object of dust removal, FIG. 3b shows that the applied voltage is a pulse DC, FIG. 3c shows that the applied voltage is a AC, FIG. 3d shows that the applied voltage is a plus DC, and FIG. 3e shows that the applied voltage is a minus DC.

In FIG. 3, the electric charge or electricity with which the dust is charged is in general of plus and/or minus polarity. In order to remove the dust 12 the voltage of plus and/or minus polarity is required. For this reason, a pulse DC, an AC or alternate current, plus DC or plus direct current, or minus DC is used.

Furthermore, although FIG. 3a shows that the voltage is applied while the electrode 30 is in contact with the conductor, or the object of dust removal 10. As the object of dust removal, either of a conductor and an insulator can be adopted, and similar voltages can be applied without contact as well to remove the dust 12, as explained in the first and second embodiments.

### 4th Embodiment

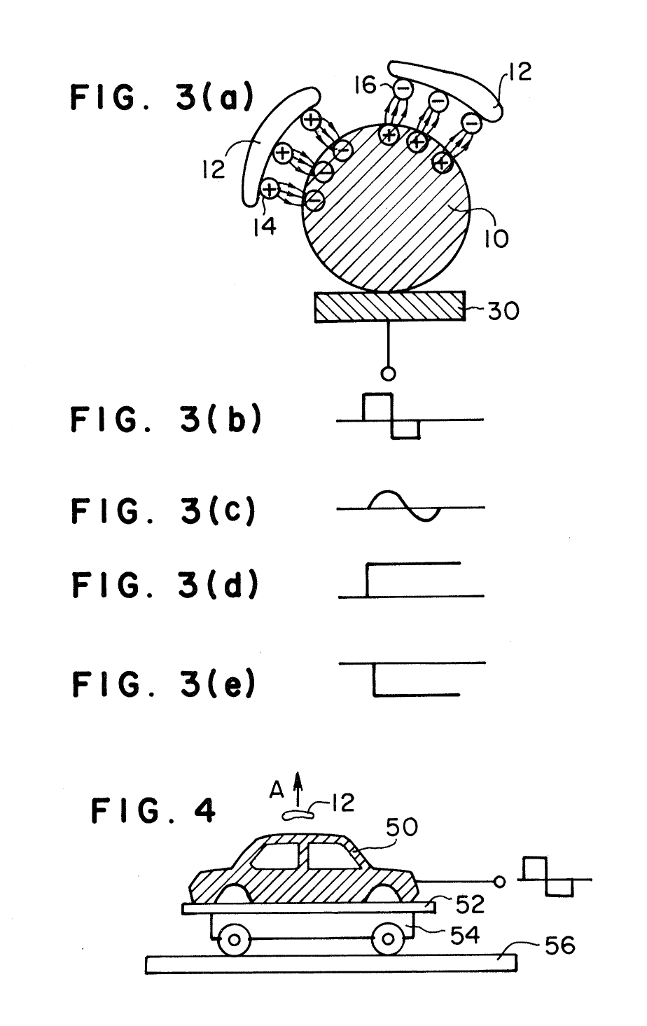

On and after the 4th embodiment, specific objects of dust removal will be explained. FIG. 4 is a view for explanation on the case in which the object of dust removal is a car body. Conventional dust removers for car include:
(1) a system in which the dust is flied away using an air blower or a fan blower,
(2) a system in which the dust is sucked in by vacuum suction,
(3) a system in which supersonic vibration is applied to facilitate the scraping of dust, and
(4) a system in which static charge is removed using a static eliminator to facilitate the scraping of dust, and the like

However, there is no dust remover which can remove the dust completely and therefore once the dust is attached to the car body, the dust is hardly removed under the conventional way.

In FIG. 4, a car body 50 is disposed above a carriage 54 through an insulator 52. The car body is transferred on a rail 56 and then is brought into the position where the dust is removed. The electrode, not shown, is brought in contact with or moved toward the car body 50 and then the pulsed voltage is applied. Consequently the dust is flied away as shown by an arrow A.

### 5th Embodiment

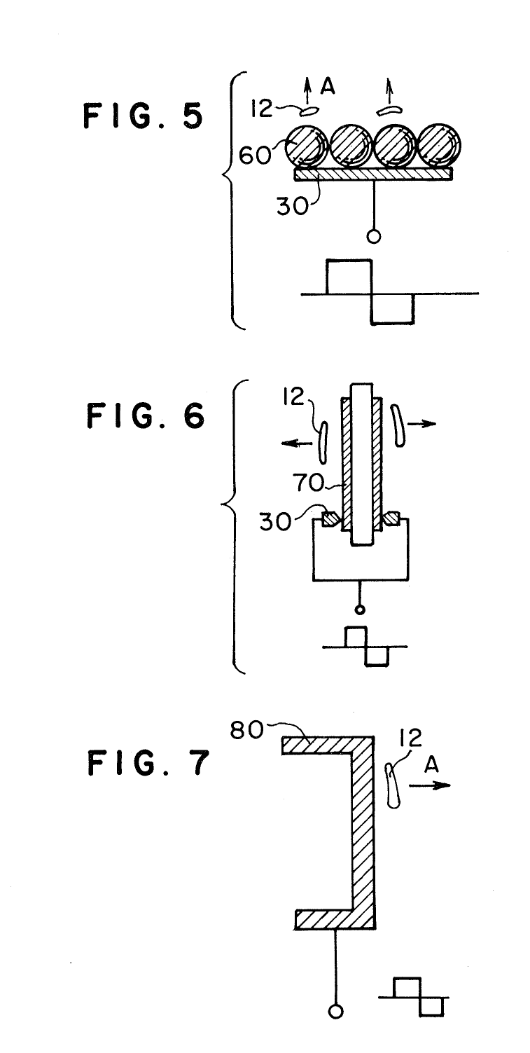

FIG. 5 is a view for explanation on the case in which the object of dust removal is a ball for use in the game “Pachinko”. In FIG. 5, the dust is flied away as shown by arrows A by applying the voltage to balls 60 or moving the electrode 30 toward the balls.

### 6th Embodiment

FIG. 6 is a view for explanation on the case in which the object of dust removal is a printed board. In FIG. 6 the dust which is attached to the circuit pattern of printed board 70 is flied away as shown by an arrow A by applying voltage to the pattern or moving the electrode 30 applied with voltage toward the pattern.

### 7th Embodiment

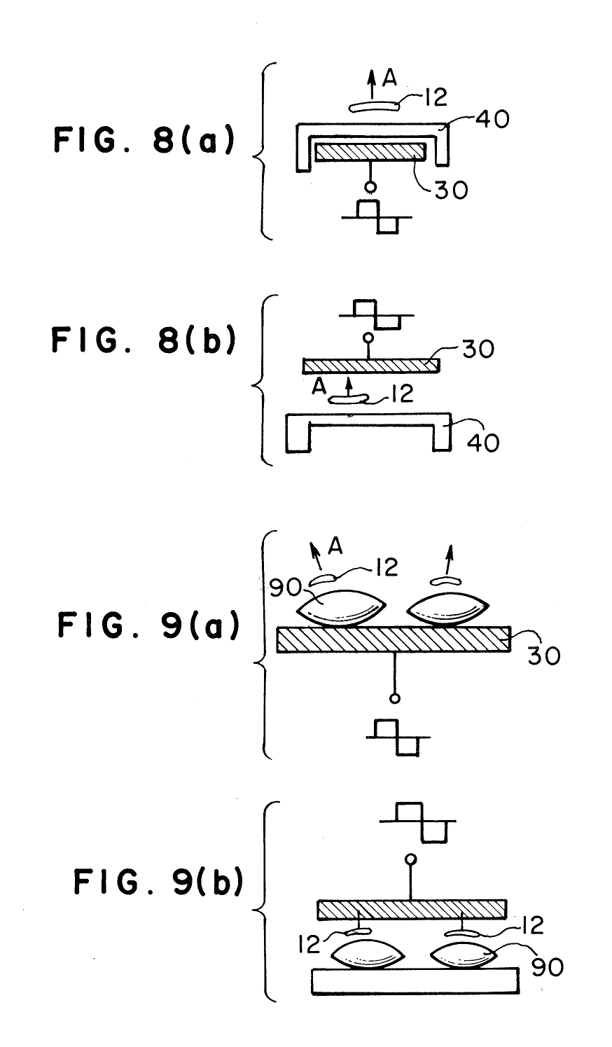

FIG. 7 is a view for explanation on the case in which the object of dust removal is a metal box such as the box of a distribution board, the box of a gas stove, the box of a personal computer, the box of a cell phone, the box of a brass instrument or the like. In FIG. 7 when the dust charged with plus or minus electricity is attached to a metal box 80, the pulsed voltage is applied with or without contact. As a result the dust charged with plus electricity is flied away by applying plus voltage and the dust charged with minus electricity is flied away by applying minus voltage as shown by an arrow A.

### 8th Embodiment

FIG. 8 is a view for explanation on the case in which the object of dust removal is an insulator such as plastic. FIG. 8a is a view for explanation on the case in which the electrode applied with voltage is moved toward the plastic from the side opposite to the dust to remove the dust from the plastic. In FIG. 8a, when the electrode 30 is plus the dust 12 charged with plus electricity is flied away, and when the electrode 30 is minus the dust 12 charged with minus electricity is flied away. FIG. 8b is a view for explanation on the case in which the electrode applied with voltage is moved toward the plastic from the side the dust is attached to remove the dust from the plastic. In FIG. 8b, when the electrode 30 is plus the dust 12 charged with minus electricity is flied away, and when the electrode 30 is minus the dust 12 charged with plus electricity is flied away. In other words, the dust is attracted toward the electrode 30.

### 9th Embodiment

FIG. 9 is a view for explanation on the case in which the object of dust removal is a plastic or a glass lens. FIG. 9a shows the case in which the electrode applied with voltage is moved toward the dust from the opposite side the dust is attached to fly the dust away. FIG. 9b shows the case in which the electrode applied with voltage is moved toward the dust from the side the dust is attached to attract the dust. In either cases the dust 12 is flied away from the lens 90.

### 10th Embodiment

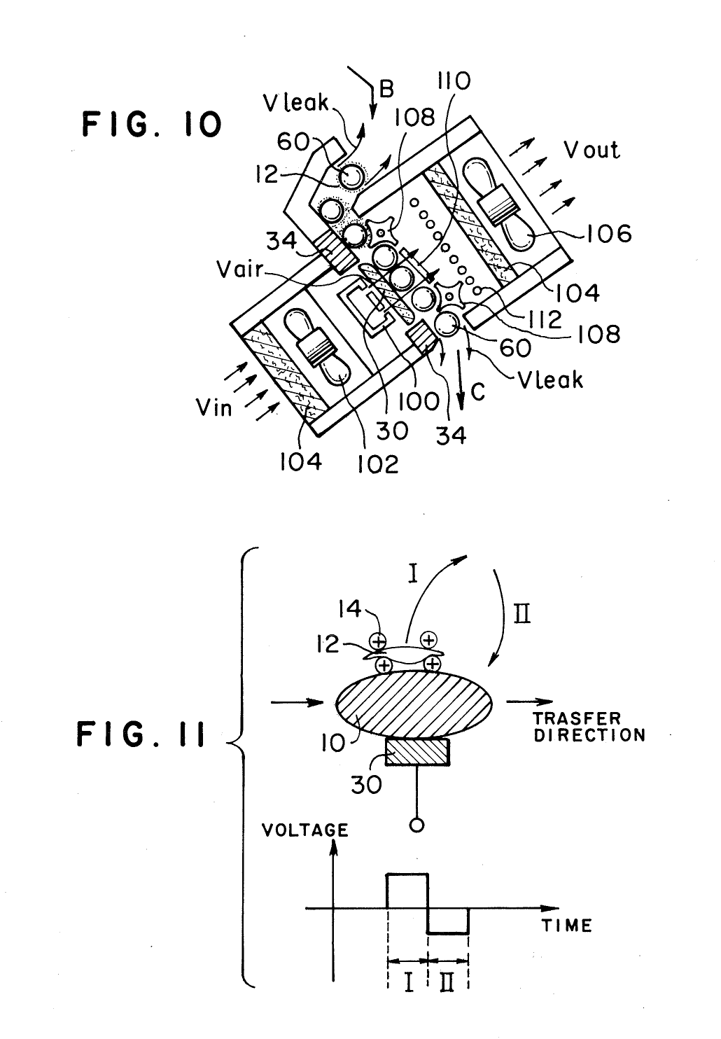

FIG. 10 is a view for more detailed explanation on the dust remover for removing dust from the balls for use in the game “Pachinko”. In FIG. 10 the balls 60 enter from the entrance gate of the dust remover as shown by an arrow B and are applied with voltage on an electrode mesh 30 to fly the dust away from the balls 60. Thereafter the balls are discharged as shown by an arrow C. Since the balls 60 are applied with voltage on the electrode mesh 30, the balls applied with voltage are isolated and insulated from those balls in the entrance or discharge gates by isolators 108. While the balls 60 on the electrode mesh 30 are applied with voltage, the balls are blown by an air blower 100 from the underside. Therefore, the dust 12 which is more likely to be removed is easily flied away. Furthermore, the numeral 110 indicates a restriction mesh, the numeral 112 indicates an array of opposed electrodes for aid to dust removal, the numeral 34 indicates grounded electrodes, and a power supply is not shown. Furthermore, although in the embodiment the dust removal for balls used in the game “Pachinko” is explained, the dust remover can be applied similarly to the dust removal for coins used in the game machine.

At that time, an inner air pressure distribution is controlled so that the removed dust is not flied away outside. Assuming that the quantity of intake air of a fan 102 with filter 104 at the inlet is Vin, the quantity of discharge air of a fan 106 with filter 104 at the outlet is Vout, the quantity of air blow is Vair, and the quantity of air leaked from the inlet and outlet for balls is Vleak, if these quantities are controlled so that the following formula consists, the removed dust does not come outside, the environment is not contaminated, and the outside dust does not enter the dust remover and therefore dust is not attached to the balls 60.

Vleak=Vin+Vair−Vout

Vleak≧0

### 11th Embodiment

Although in the aforementioned embodiments 1 to 10, only an application of voltage is fundamentally used to remove the dust, on and after the 11th embodiments an application of voltage and other means are combined to enhance the effects of dust removal. To begin with, before the 11th embodiment is explained, the dust-return phenomenon will be explained. FIG. 11 is a view for explanation on the dust-return phenomenon. As shown in FIG. 11 when the dust repelling electrode 30 is applied with pulsed voltage in a phase I that the applied voltage has the same polarity as that of the electric charge with which the dust is charged, the dust is flied away from the object of dust removal due to repulsive force. In next opposite phase II, the dust returns to the object of dust removal due to attracting force and is attached to the object of dust removal again. As the frequency of pulsed voltage applied to the electrode becomes higher more numerous objects of dust removal can be treated. However, as the frequency is higher, the dust is attracted before the dust is flied away enough and is attached to the object of dust removal again. For this reason, as long as the transfer speed of object of dust removal is limited, the frequency of power supply is limited and therefore handling capacity is limited.

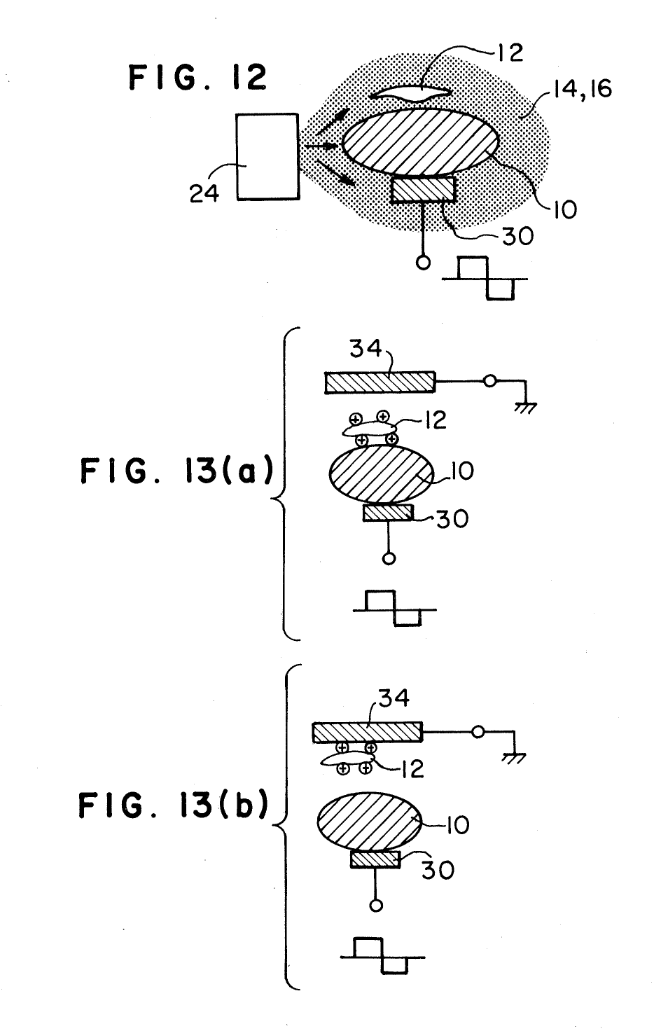

FIG. 12 is a view showing the dust remover of the 11th embodiment. In FIG. 12 an ionizer or ion generating device issues ions 14 and 16 (plus and minus ions) toward the circumference of the object of dust removal 10 which is being dust removed by the dust remover. In that case the ionizer having a good balance between plus and minus ions is used. When the voltage of same polarity with that of dust is applied to the dust repelling electrode 30 the dust is flied away. The dust floating in the air turns (out) to be discharged since the electricity with the dust is charged attracts the ions of opposite polarity. Since the dust without charge is not attracted when the voltage of opposite polarity is applied, reattachment of the dust is avoided. Therefore it can be applied to the dust removal of the object which is moved at a low speed.

### 12th Embodiment

FIG. 13 is a view showing the dust remover of the 12th embodiment, FIG. 13a shows the state that the dust is attached to the object of dust removal, and FIG. 13b shows the state that the dust is removed from the object of dust removal. In FIG. 13 a dust attracting opposite electrode 34 which is grounded is provided above the dust repelling electrode 30 on the opposite side of the object of dust removal 10, when the pulsed voltage is applied to the dust repelling electrode under the circumstances of dust attachment as shown in FIG. 13a the dust 12 is flied away from the object of dust removal 10 due to the voltage applied from the dust repelling electrode 30. Either of the dust charged with plus electricity and the dust charged with minus electricity is attached to the dust attracting electrode 34. In other words since the dust 12 is removed without return to the object of dust removal 10, the frequency of the voltage applied to the dust repelling electrode 30 can be made higher, and therefore the moving speed of the object of dust removal can be made lower.

### 13th Embodiment

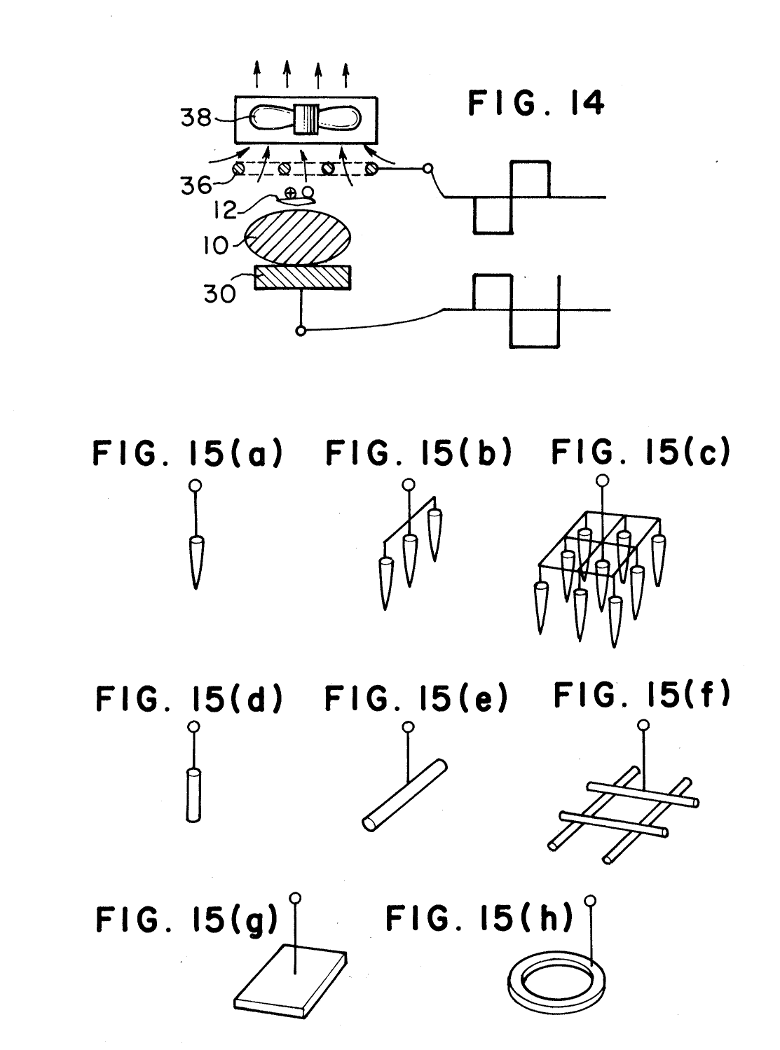

FIG. 14 is a view showing the dust remover of the 13th embodiment. In FIG. 14 a dust attracting opposite electrode 36 such as mesh type or lattice type of electrode is provided instead of the grounded dust attracting opposite electrode 34 used in the 12th embodiment and further a dust suction fan 38 is provided above the electrode 36. The pulsed voltages of opposite polarities as shown in FIG. 14 are respectively applied to the dust repelling electrode 30 and the dust attracting electrode 36.

Now, when the voltages of opposite polarities are applied to the dust repelling electrode 30 and the dust attracting electrode 36 the dust is removed from the object of dust removal by the dust repelling electrode 30 and simultaneously the dust is attracted by the dust attracting electrode 36. For this reason since the repelling force and attracting force are applied to the dust at the same time, the dust is likely to be removed. The dust attached on the dust attracting electrode 36 departs from the dust attracting electrode 36 since the voltage applied to the dust attracting electrode 36 is switched over from one polarity to the other polarity. The dust thus departed is collected by the dust suction fan 38.

### 14th Embodiment

FIG. 15 is a perspective view showing more detailed examples of electrodes, that is, dust repelling electrode and dust attracting electrode. Although the electrodes (dust repelling electrode and dust attracting electrode) are shown diagrammatically in the previous embodiments. One of any proper shapes can be adopted as this electrode and for example such shapes as shown in FIG. 15 can be used. The shapes include (a) a needle shape with (its) pointed end (leading end pointed), (b) one dimensional array of needle shape of electrodes, (c) two dimensional array of needle shape of electrodes, (d) a rod electrode one of the edges is used, (e) line or rod-like shape, (f) mesh shape, (g) plate-like shape and (h) ring shape, and the like.

### 15th Embodiment

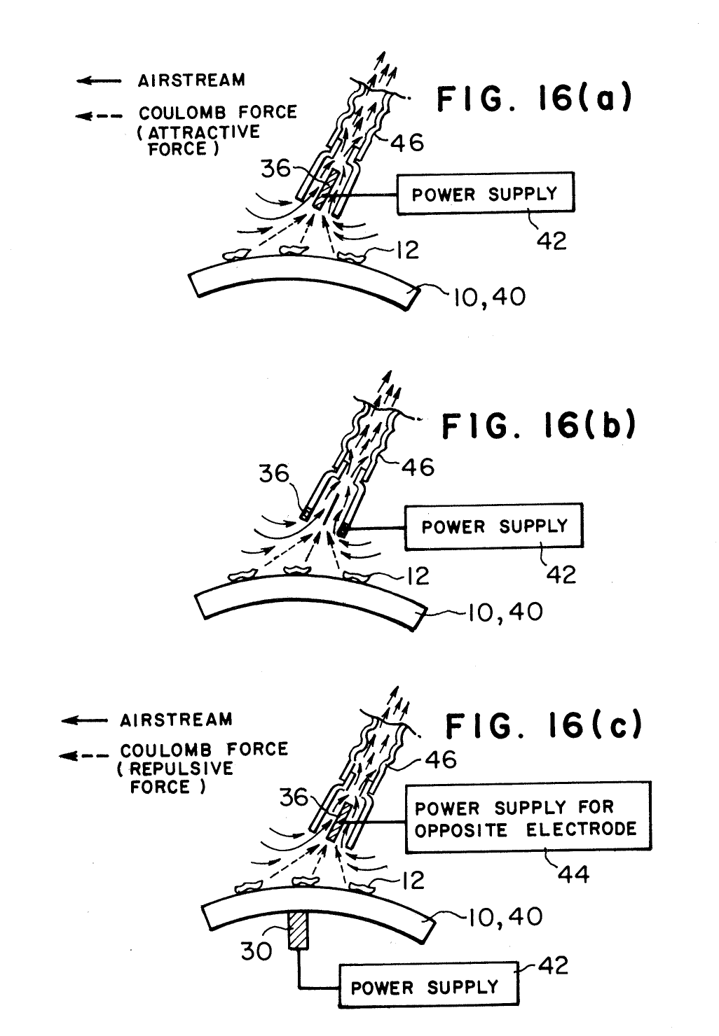

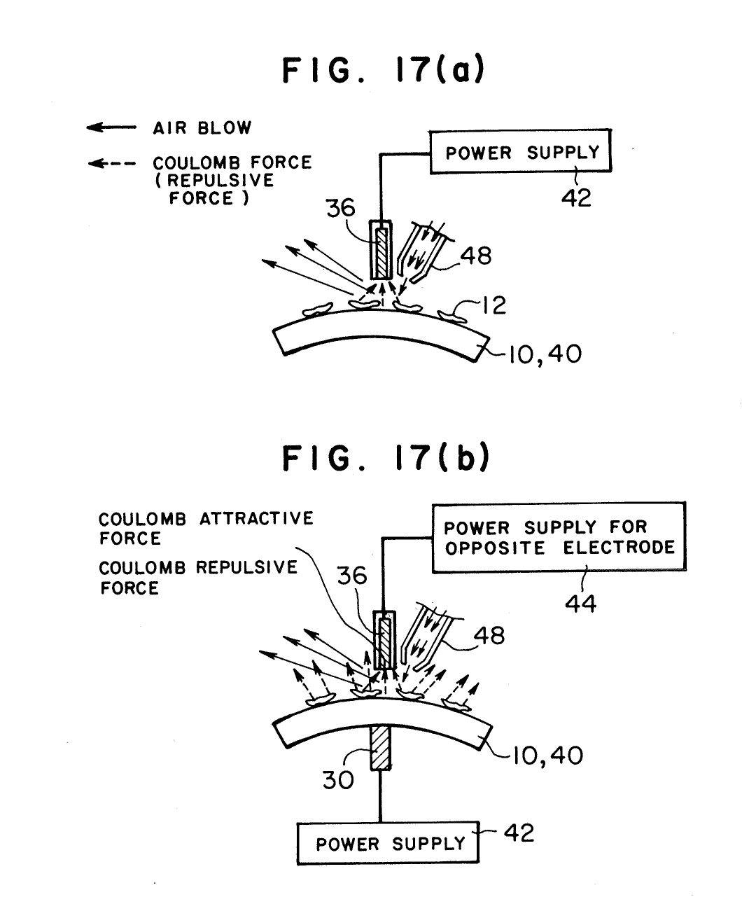

FIG. 16 is a view showing three examples of the dust remover provided with a dust suction device according to the 15th embodiment, FIGS. 16a and 16b show the examples in which a dust suction vacuum device and a dust attracting electrode are disposed on the same side of the object of dust removal, and FIG. 16c shows the example in which a dust suction vacuum device and a dust repelling electrode are disposed on the opposite side of the object of dust removal. In FIG. 16 on each example the object of dust removal may be an insulator 40 or a conductor 10, a dust suction vacuum device 46 is disposed above the object of dust removal 10/40. As an example shown in FIG. 16a, the dust attracting electrode 36 fed by a power supply 42 is disposed inside a dust suction vacuum device 46, as an example shown in FIG. 16b the dust attracting electrode 36 fed by a power supply 42 is disposed on circumferential leading end of the dust suction vacuum device 46. The dust attracting electrode 36 include various type of shapes such as a point-like one, a ring-like one, or the like. The dust is attracted by electric attracting force generated by the dust attracting electrode 36 and then the floating dust or the dust likely to float is sucked and collected by the vacuum suction device 46.

As an example in FIG. 16c, the dust is repelled by electric repelling force generated by the dust repelling electrode 30 fed by the power supply 42 opposed at the opposite side of the object of dust removal 10/40 against the suction and then the floating dust or the dust likely to float is sucked and collected by the vacuum suction device 46. At that time although it is preferred that the dust attracting electrode 36 is provided on the side of the vacuum suction device 46 to suck the dust in, the dust attracting electrode 36 may be not provided. The dust attracting opposite electrode 36 is grounded or is applied with the voltage of opposite polarity to that of the dust repelling electrode. If the dust attracting opposite electrode is applied with the voltage of opposite polarity to that of the dust repelling electrode the dust is attracted by stronger force.

### 16th Embodiment

FIG. 17 is a view showing a dust remover provided with an air blower according to 16th embodiment, FIG. 17a shows the case in which a dust attracting electrode and an air nozzle of air blower are disposed on the same side of the object of dust removal, and FIG. 17b shows the case in which a dust repelling electrode and an air nozzle of air blower are disposed on the opposite side of the object of dust removal.

As shown in FIG. 17 an air blower 48 is disposed adjacent the dust attracting electrode to blow the air toward the object of dust removal. The object of dust removal may be either an insulator 10 or a conductor 40.

As shown in FIG. 17a the dust attracting electrode 36 attracts the dust and then the floating dust or the dust likely to float is blown out by air blow from the air blower 48. As shown in FIG. 17b the dust repelling electrode 30 repels the dust 12 and then the floating dust or the dust likely to float is blown out by air blow from the air blower 48. At that time it is preferred that the dust attracting electrode 36 (may be) is provided on the same side of the air blower although it isn't necessarily needed. The dust attracting electrode 36 is grounded. Alternatively the voltage of the dust attracting electrode 36 is made to have an opposite polarity to that of the dust repelling electrode 30. If so, stronger attracting force can be obtained.

### 17th Embodiment

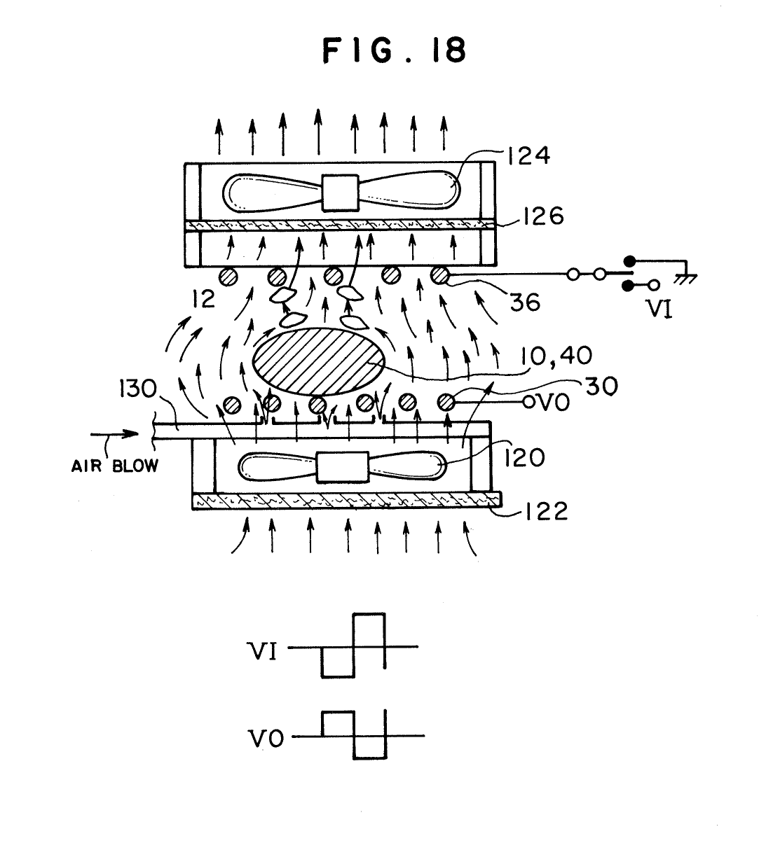

FIG. 18 is a view showing the dust remover according to 17th embodiment. In FIG. 18, on the upper stream side of the object of dust removal 10/40, dust repelling electrode 30 such as a mesh-like one, a dust blowing-out fan 120 with filter 122, and air blow tube 130 through which air is supplied to blow out the dust are provided, and on the downstream side of the object of dust removal, the dust attracting electrode 36 such as a mesh-like one and a dust suction fan 124 with a filter 126 are provided. As shown in FIG. 18 the dust attracting electrode 36 is grounded. Alternatively the voltage Vi of the dust attracting electrode 36 is made to have an opposite polarity to the voltage V0 of the dust repelling electrode 30. If so, stronger attracting force can be obtained.

### 18th Embodiment

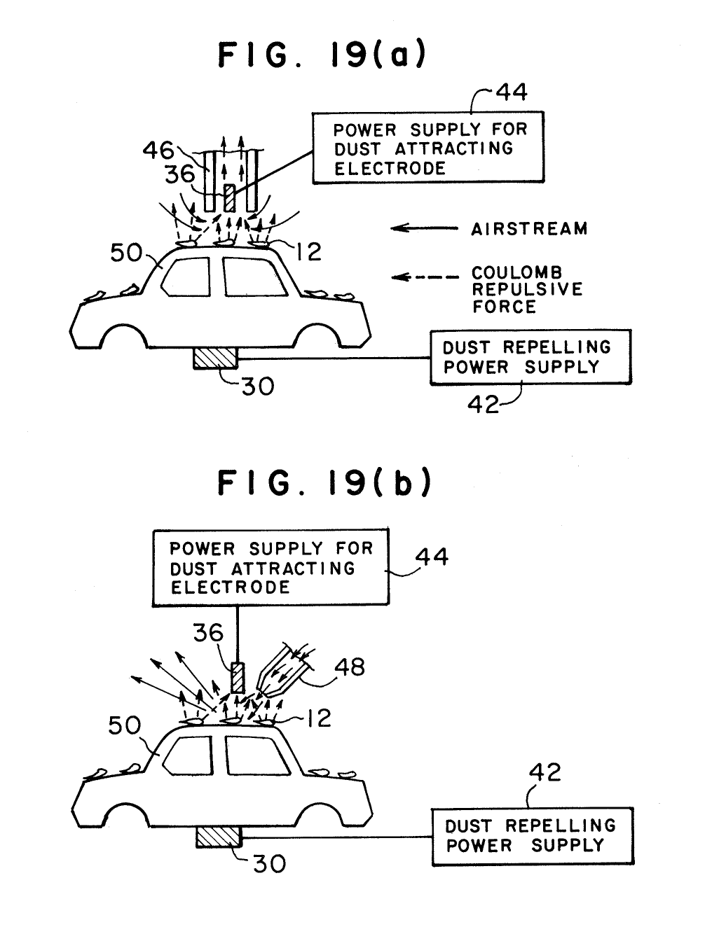

FIG. 19 is a view showing the embodiment in which the object of dust removal is a car body, FIG. 19a shows the example of car body corresponding to the embodiment shown in FIG. 16c and FIG. 19b shows the example of car body corresponding to the embodiment shown in FIG. 17b. In FIG. 19a the dust repelling electrode 30 is directly connected to the car body 50 or is made to approach to the car body from the opposite side of the dust attached surface without contact to repel the dust. Furthermore the dust attracting electrode 36 is provided at the vacuum suction inlet of the dust suction vacuum device 46 to suck the dust in. The floating dust or the dust likely to float is collected by vacuum suction. The dust attracting electrode 36 is grounded. Alternatively the voltage of the dust attracting electrode 36 is made to have an opposite polarity to the voltage of the dust repelling electrode 30. If so, stronger attracting force can be obtained.

In FIG. 19b the dust repelling electrode 30 is directly connected to the car body 50 or is made to approach to the car body from the opposite side of the dust attached surface without contact to repel the dust. Furthermore the air nozzle of air blower is provided adjacent the dust attracting electrode 36 to blow out the dust 12. The floating dust or the dust likely to float is blowed out by the air blow from air blower. The dust attracting electrode 36 is grounded. Alternatively the voltage of the dust attracting electrode 36 is made to have an opposite polarity to the voltage of the dust repelling electrode 30. If so, stronger attracting force can be obtained.

It is understood that many modifications and variations may be devised given the above description of the principles of the invention. It is intended that all such modifications and variations be considered as within the spirit and scope of this invention, as it is defined in the following claims.

1. A method of removing dust charged with static electrical charges of one polarity so as to be electrostatically attached to an object for dust removal comprising:
(a) providing a repelling electrode charged with one polarity, the same as that of the static charges of dust electrostatically attached to the object, near or in contact with a first side of the object in order to cause charges of the one polarity to be generated on a second side of the object to which the dust is attached to be repelled from the object,
(b) providing an attractive electrode charged with an opposite polarity in proximity to the second side of the object in order to attract dust away from the second side of the object, and
(c) providing a suction device in proximity to the second side of the object positioned around or adjacent to the attractive electrode in order to suction away dust repelled by the one polarity of the repelling electrode and attracted by the opposite polarity of the attracting electrode, thereby obtaining an effective detachment of dust and suctioning away of the dust for removal from the object.

2. A method according to claim 1, adapted for use with a pachinko machine having a plurality of metal pachinko balls used therein, wherein the repelling electrode is electrically connected to an electrode mesh on which pachinko balls entering the machine pass over so that dust is repelled from them, the attractive electrode is electrically connected to an opposing mesh toward which the dust is attracted, and the suction device is a blower fan for blowing out the removed dust.

3. A method according to claim 1, wherein a voltage is applied to the repelling electrode that is a pulsed voltage of plus and minus pulses or an AC voltage.

4. A method according to claim 1, wherein a voltage is applied to the repelling electrode that is a pulsed voltage of plus and minus pulses or an AC voltage, and the attractive electrode is an ion generating device issuing plus and minus ions to which the dust is attracted.

5. A method according to claim 1, wherein a voltage is applied to the repelling electrode that is a pulsed voltage of plus and minus pulses or an AC voltage, and the attractive electrode is electrically grounded.

6. A method according to claim 1, wherein a voltage is applied to the repelling electrode that is a pulsed voltage of plus and minus pulses or an AC voltage, the attractive electrode is a mesh electrode to which pulsed voltage of minus and plus pulses or an opposite AC voltage is applied, and the suction device is a suction fan positioned downstream of the mesh electrode.

7. A method according to claim 1, wherein the suction device is a dust suction vacuum having walls surrounding the attracting electrode.

8. A method according to claim 1, wherein the repelling electrode is an upstream mesh electrode with an upstream air blower fan blowing air downstream through the repelling mesh electrode, the attracting electrode is a downstream mesh electrode, and the suction device includes a downstream air blower fan downstream from the attracting mesh electrode.

9. A method according to claim 1, adapted for removing dust from a car body, wherein the repelling electrode is connected to an underside of the car body, and the attracting electrode is positioned adjacent the suction device on an upper side of the car body.

10. A method of removing dust charged with static electrical charges of one polarity so as to be electrostatically attached to an object for dust removal comprising:
(a) providing an attractive electrode charged with one polarity in proximity to the one side of the object in order to attract dust away from the one side of the object, and
(b) providing a suction device in proximity to the one side of the object positioned around or adjacent to the attractive electrode in order to suction away dust, thereby obtaining an effective detachment of dust and suctioning away of the dust for removal from the object.
